(19) United States
(12) Patent Application Publication
(10) Pub. No.: US 2004/0265500 A1
(43) Pub. Date: Dec. 30, 2004

(54) Coating process utilizing automated systems

(76) Inventors: Helmut W. Kucera, West Springfield, PA (US); Douglas H. Mowrey, Titusville, PA (US); Rebecca S. Cowles, Wattsburg, PA (US)

Correspondence Address: LORD CORPORATION, 111 Lord Drive, P.O. 8012, Cary, NC, 27512-8012, US

(21) Appl. No.: 10/609,116

(22) Filed: Jun. 27, 2003

(51) Int. Cl. B05D 1/18

(52) U.S. Cl. 427/443.1

(57) ABSTRACT

A method for applying at least one coating composition to an electrochemically active metal substrate, and the coated substrate produced thereby are disclosed. Preferably, an articulable electromechanical device such as a robot arm is utilized to aid in precision coating electrochemically active metal substrates, particularly complex shaped electrochemically active metal substrates through autodeposition. The electromechanical device is articulable through a wide range of motions and can substantially eliminate drip edges or pockets of retained coating in otherwise poorly draining areas of the substrate, producing fully and/or evenly coated, aesthetically pleasing coated substrates. Throughput of coated substrates is maximized through the method of the present invention.

### FIELD OF THE INVENTION

The present invention relates to a method wherein at least one coating composition is applied to a metal substrate through the use of a microprocessor controlled automated system, and the coated substrate produced thereby. In a preferred embodiment an electromechanical device, such as a robotic arm, is utilized to precision coat electrochemically active metal substrates, particularly complex shaped metal parts through autodeposition. The electromechanical device is articulable through a wide range of motions to eliminate drip edges, tears or pockets of retained coating in otherwise poorly draining areas of the substrate, producing fully and/or evenly coated, aesthetically pleasing coated substrates. Throughput of coated substrates is maximized through the methods of the present invention. Control of dry film thickness is obtained utilizing the methods of the invention.

### BACKGROUND OF THE INVENTION

It is generally known that various properties, such as corrosion resistance, of metal substrates are improved by coating the substrate with an autodeposition composition. Autodeposition, as known in the art, is the formation of a coating or film on an electrochemically active substrate, generally by immersion in an appropriate medium, such as an aqueous resin. The general principles and advantages of autodeposition are explained in a multitude of patents assigned to Parker Amchem and/or Henkel (see, for example, U.S. Pat. Nos. 4,414,350; 4,994,521; 5,427,863; 5,061,523 and 5,500,460). The prior art autodeposition methods claim that uniform coating or film thickness is achieved utilizing dipping or immersion techniques. The prior art autodeposition methods make use of large dip tanks having autodeposition compositions therein. These large tanks have low turnover ratios or capabilities. One problem encountered is that over time, the components of the autodeposition compositions become disproportional, resulting in inconsistent coating properties and/or performance. Moreover, the large dip tanks are also subject to the buildup of impurities. The prior art techniques have been found to have problems with the film thickness due at least to inconsistent exposure times to the autodeposition composition, as well as drip lines or excess composition drainage.

Control of dry film thickness is critical for corrosion protection and adhesive performance. In order to maintain dry film thickness within a close tolerance range, conventional coating must be applied at very specific viscosities. Coatings too thin or too thick result in poor adhesive qualities. Autodepositable adhesives provide better dry film thickness control. However, these conventional materials have relatively slow cycle times and are thus hard to automate and uneconomical. It would be industrially important to provide precise control of dry film thickness and faster cycle times to enable use of microprocessor controlled automated application processes or systems.

### SUMMARY OF THE INVENTION

According to the present invention, methods are provided for applying at least one coating composition to an electrochemically active metal substrate. Precise control of dry film thickness is obtained, even on complex shape parts with the methods of the present invention. In a preferred embodiment, the coating composition is applied utilizing a microprocessor controlled automated device such as an articulable electromechanical device. In one embodiment, the at least one coating is an aqueous surface treatment composition. In a further embodiment, two or more different aqueous surface treatment compositions are applied to the electrochemically active metal substrate sequentially.

In one embodiment, a metal treatment is applied to the electrochemically active metal substrate through autodeposition. In another embodiment, a metal treatment coating and a separate primer coating or an adhesive overcoating composition is applied to the substrate through autodeposition. In yet another embodiment, a composition is applied to an electrochemically active metal substrate, wherein the coating functions as a metal treatment, a primer and an adhesive, by autodeposition. One preferred embodiment of the composition for application to the electrochemically active metal substrate includes an acid, an accelerator, and an autodepositable polymer.

The method for applying at least one coating composition is performed with a microprocessor controlled automated electromechanical device, preferably a robotic arm, which is articulable through an extensive array of motions, actions and/or travel paths. Use of the articulable electromechanical device to facilitate coating of the substrate prevents or eliminates drip edges or pockets of pooled coating which would otherwise be present on the coated substrate.

The electromechanical device comprises a substrate grasping element which allows for precise control and movement of the substrate. The substrate grasping element has any number of forms which are at least somewhat dependent on the shape, size, dimensions, etc. of the substrate. Suitable grasping elements are grasping means such as “fingers” or “hands”, magnets, suction elements, pins, hooks, or the like. The method of the present invention is preferably practiced in a relatively compact area.

In one method of the present invention, the microprocessor controlled articulable electromechanical device is employed to guide a substrate through an autodeposition procedure. In one embodiment of the method, a substrate is retrieved from a defined, registered location by the electromechanical device, more specifically the grasping element thereof. The substrate is moved to an autodeposition tank or bath and immersed in a first autodeposition composition. Therein, the electromechanical device is optionally articulated as appropriate to remove any air bubbles or entrapped air so that the substrate is thoroughly coated. Then, the substrate is withdrawn from the bath after a predetermined time at a predetermined rate and orientation to remove or drain any excess or trapped coating. The autodeposited substrate is optionally articulated after withdrawal from the bath. The articulated motion performed on the coated substrate prevents drip lines and provides a controlled coating thickness. The coated substrate is transferred by the electromechanical device to a drying device for a predetermined period of time. Afterwards, the coated substrate is optionally transferred by the electromechanical device to a baking device for further curing or drying. The electromechanical device then transfers the coated substrate into a substrate receiving area for shipping, further processing, etc.

In a further embodiment, before the coated substrate having first autodeposition composition thereon is cured, an additional second autodeposition composition is applied. In this embodiment, the electromechanical device transfers the coated part to a second autodeposition tank wherein the coated substrate is immersed and preferably articulated in a second composition which is preferably different than the first composition. The coated substrate is removed from the second autodeposition composition and articulated through a range of motions as stated above, which is different from or the same as the first articulation motion. The coated substrate is transferred by the electromechanical device to a device for drying. Afterwards, the coated substrate is optionally transferred by the electromechanical device to a baking device for further curing or drying. The electromechanical device then transfers the coated substrate into a substrate receiving area for shipping, further processing, etc.

The method of the present invention utilizing the electromechanical device maximizes throughput of articles in an autodeposition process and hence reduces manufacturing costs and/or time. The autodeposition method utilizing an electromechanical device, such as robotic arm, is particularly useful to provide a metal surface of a substrate with corrosion protection and/or a primer for a further use, such as in rubber-to-metal bonding process. Further, the process is performed with a rinsing step(s) if desired, as typically performed in prior art processes. The present invention offers great transfer efficiency of wet chemistry. Moreover, rapid turnover of small baths is possible, allowing the use of compositions with short shelf lives, especially compositions comprising components that are not stable in each other for very long periods of time. Precise control of dry film thickness on a substrate is advantageously achieved

### BRIEF DESCRIPTION OF THE DRAWINGS

The invention will be better understood and other features and advantages will become apparent by reading the detailed description of the invention, taken together with the drawings, wherein:

FIG. 1 is a schematic diagram for one embodiment of an apparatus for performing the autodeposition coating processes according to the present invention.

### DETAILED DESCRIPTION OF THE PREFERRED EMBODIMENTS

The embodiment of the coating methods according to the present invention are specifically described with reference to the drawings. Unless otherwise indicated, description of components in chemical nomenclature refers to the components at the time of addition to any composition specified in the description, but does not necessarily preclude chemical interactions among the components of a mixture once mixed.

The coating of the present invention is performed on electrochemically active metal substrates or surfaces. “Electrochemically active metals” means those substrates treated according to the present invention process and means iron and all metals and alloys more active than hydrogen in the electromotive series. Examples of electrochemically active metal surfaces include, but are not limited to, zinc, zinc-phosphatized steel, iron, aluminum and cold-rolled, polished, pickled, hot-rolled and galvanized steel, ferrous iron and alloys of iron.

“Phenolic compound” means a compound that includes at least one hydroxy functional group attached to a carbon atom of an aromatic ring. Illustrative phenolic compounds include unsubstituted phenol per se, substituted phenols such as alkylated, alkoxy-phenols, chloro-phenols, and multi-hydroxy phenols, and hydroxy-substituted multi-ring aromatics, e.g. phenolic novolac, and phenolic resoles. Illustrative alkylated phenols include methylphenol (also known as cresol), dimethylphenol (also known as xylenol), 2-ethylphenol, pentylphenol and tert-butyl phenol.

“Multi-hydroxy phenolic compound” optionally employed for modifying phenolic resins adaptable in the present process, means a compound that includes more than one hydroxy group on each aromatic ring. Illustrative multi-hydroxy phenols include 1,3-benzenediol (also known as resorcinol), 1,2-benzenediol (also known as pyrocatechol), 1,4-benzenediol (also known as hydroquinone), 1,2,3-benzenetriol (also known as pyrogallol), 1,3,5-benzenetriol and 4-tert-butyl-1,2-benzenediol (also known as tert-butyl catechol). Illustrative hydroxy-substituted multi-ring aromatics include 4,4′-isopropylidenebisphenol (also known as bisphenol A), 4,4′methylidenebisphenol (also known as bisphenol F) and naphthol.

“Aldehyde compound” is used to condense with a phenolic compound and means a compound having the generic formula of a hydrocarbyl moiety-CHO. Illustrative aldehyde compounds include formaldehyde, acetaldehyde, propionaldehyde, n-butylaldehyde, n-valeraldehyde, caproaldehyde, heptaldehyde and other straight-chain aldehydes having up to 8 carbon atoms in the hydrocarbyl group, as well as compounds that decompose to or are derived from formaldehyde such as paraformaldehyde, trioxane, furfural, hexamethylenetriamine, acetals that liberate formaldehyde on heating, and benzaldehyde.

“Phenolic resin” generally means the reaction product of a phenolic compound with an aldehyde compound. The molar ratio of the aldehyde compound (for example, formaldehyde) reacted with the phenolic compound is referred to herein as the “F/P ratio”. The F/P ratio is calculated on a per hydroxy-substituted aromatic ring basis.

“Phenolic resin precursor” means an unmodified or conventional phenolic resin that is reacted with the modifying agent to produce an autodepositable phenolic resin dispersed in an aqueous phase.

The term “hydrocarbyl moiety” refers to an organic moiety which is aromatic, aliphatic or a combination of aromatic and aliphatic moieties, and optionally containing O, N, S and/or P as a substituents, or components intervening in the parent chain or backbone of the structure.

The term “aryl” when used alone refers to an aromatic radical or group, whether or not fused. Exemplary aryl groups include phenyl, naphthyl, biphenyl, and the like. “Heteroaromatic” groups include, but are not limited to, furanyl, pyrrolyl, thienyl, pyrazolyl, thiazolyl, oxazolyl, pyridyl, pyrimidinyl, indolyl, and the like.

The term “substituted aryl” denotes an aryl or heteroaryl group substituted in any one (e.g. 1, 2, 3, 4, 5, etc.) or more available sites on a ring, and include independently chosen substituents, such as halogen, cyano, nitro, C, —C₁₀ alkyl, C₁-C₁₀ alkylol, C₁-C₁₀-alkyloxy, C₁-C₁₀-oxyalkyl, C₁-C₁₀-carboxylic acid, C₁-C₁₀ sulfonic acid, C₁-C₁₀-carboxylic ester, C₁-C₁₀-caboxylic amide, trifluoromethyl, alkyloxycarbonyl, and the like. Examples of such groups are 4-chlorophenyl, 2-methylphenyl, 3-ethoxyphenyl, and orthomethylol.

The term “arylalkyl” means one or more aryl groups having a designated number of carbons, substituted on a hydrocarbyl radical or moiety. Exemplary arylalkyl groups are C₆-C₃₀ aryl substituents on a C₁-C₂₀ or C₁-C₁₀ alkyl radical. An exemplary arylalkyl group is a benzyl group, tolyl group, xylyl group, and a 2-ethylhexyl phenyl.

The term “alkenyl” refers to a straight or branched chain group of from two to ten carbon atoms containing a carbon-carbon double bond, including, but not limited to allyl, vinyl, and the like.

The coating compositions listed or disclosed within a specific coating method step section are only illustrative examples. The method steps are not limited thereto. Throughout other sections of the specification numerous coating compositions are described which are also preferred for use in practicing the method steps of the invention.

While not wishing to be bound to any particular theory, it is believed that one method of this invention is based on the principles of autodeposition. The term “autodeposition” is defined as the depositing of an aqueous dispersed resin from a dispersion on the surface of an electrochemically active metal substrate, or metal treated surface. In the case of autodeposition on the bare metal, multivalent ions (for example, ferric and/or ferrous ions in the case of steel) released by activating acid cause the deposition of the metal treating composition leave a uniform, gelatinous, highly acidic wet film. As the film dries (the drying is accelerated by heating) the remaining acid converts the surface of the respective metal compound to the respective negative ion of the acid (for example, metal phosphate in the case of phosphoric acid) forming an interpenetrating network with chelating groups of the aqueous dispersed phenolic resin. The autodeposition of a second or subsequent coating is activated by materials migrating from the metal treatment step.

Autodepositable compositions are known to include water, resin solids dispersed in the aqueous medium, and an activator. For example, the aqueous autodeposition solution in one commercial embodiment contains 3-5 percent solids of a latex (polyvinylidene chloride or acrylic) and carbon black, ferric fluoride and a low concentration of hydrofluoric acid to provide a solution pH of 1.5-3.0. According to one embodiment of the invention, multi-layered coating is formed on a substrate in a first and second dip process. A clean, degreased metal substrate is immersed in an autodeposition solution for a few seconds to two minutes optionally dried and retreated with an overcoating which autodeposits on intimate contact with the first autodeposited coating. The dispersed resin solid typically is derived from ethylenically unsaturated monomers. Autodepositable resins include epoxies, PVDC copolymers, acrylics, phenolic dispersions, and combinations of any of these. The most preferred autodeposition resins used herein are modified phenolic dispersions disclosed in U.S. Pat. Nos. 6,130,289, 6,383,307, 6,476,119 and copending application Ser. No. 10/138,957, each of which is incorporated herein by reference. According to U.S. Pat. No. 5,486,414, incorporated herein by reference, AUTOPHORETIC® 800 Series compositions are based on polyvinylidene chloride and AUTOPHORETIC® 700 Series compositions are based on acrylic resins.

In the case of metal treatment of zinc-rich surfaces (e.g., galvanized steel), PCT International Patent Application Publication No. WO 97/09127, herein incorporated by reference, discloses treating the surface prior to autodeposition with a composition consisting of water, dissolved phosphonate (for example, diethylene triaminepenta(methylene phosphonic acid) or aminotri(methylene phosphonic acid)), aromatic sulfonate surfactant (for example, disulfonated derivative of dodecyl ether (DOWFAX 2A1 or 2A0)), and dissolved non-oxidizing acid (for example, hydrochloric acid).

The autodeposition characteristic of the invention is important to provide corrosion resistance. The method of the invention allows for the formation of an exceptionally uniform film having a dry film thickness in the range of 2.5 to 25.4 micrometers, and preferably from 5.0 to 20.3 micrometers. The dry film thickness is provided at a cycle time of 1 to 10 seconds. Excellent corrosion resistance is possible only if the entire surface of a metal part is protected with a barrier coating. This requirement is usually difficult to achieve on substrate surfaces that have very complex topology. With the superior autodeposition methods of this invention, wetting and thus protection of such complex surfaces is achieved. A further advantage of the metal treatment is that it activates a metal surface for autodeposition of a subsequently applied coating or primer.

In accordance with the present invention a method of sequential dipping of electrochemically active metal substrates or parts in one or more autodeposition compositions is disclosed. In one embodiment the first autodeposition or dipping tank contains an autodepositable acidic aqueous phenolic dispersion which provides anticorrosive properties to the metal substrate. In a further embodiment, in a second dipping step in a second tank, an autodeposited overcoating resin is applied and serves as a primer coating or an adhesive overcoat. In yet another embodiment, an autodeposition composition is applied to an electrochemically active metal substrate, wherein the composition has metal treatment, primer and adhesive properties. The methods of the present invention provide corrosion resistance and uniform film thickness on complex shaped metal parts.

When referred to in the present invention, the term articulable electromechanical device means a mechanical device which is operatively connected to and controllable by a microprocessor such as a computer or central processing unit. The articulable electromechanical device is programmed as known in the art to execute a series of recognizable commands to perform various facets of the method of the invention. The term “articulate” is defined as, but not limited to, motions such as movement of at least a portion of the electromechanical device from a first point to a second point, rotations, accelerations at different rates, spring movements, gyrations, moving in an arc, moving up and down, twisting in a defined space, moving in an arc with simultaneous rotation, pivoting about a pivot point and the like, or a combination and/or sequences thereof.

The preferred electromechanical device of the present invention is a “robot arm” which is made of one or more operatively connected parts. In one embodiment, the robot arm performs jointed movements similar in function as a human arm, but with even greater range. The robot arm has numerous interconnected jointed segments similar in function or movement as a human trunk, shoulder, arm, elbow, wrist, hand, fingers, etc. which allow the arm to perform articulate motions as described hereinabove. Such electromechanical devices are well known and commercially available from suppliers such as CRS Robotics of Burlington, Ontario, Canada; Kawasaki Robotics of Wixom, Mich.; Toshiba of Elk Grove Village, Ill.; and Stäubl Unimation of Duncan, S.C. A preferred electromechanical device is a robotic arm from CRS as model F3.

As mentioned above, the electromechanical device is equipped with a substrate or part grasping element or means which is adapted for or capable of grasping, holding, retaining, carrying, securing, etc. a substrate and performing a series of functions therewith, including articulation movements. According to the invention, numerous different types of grasping elements are contemplated. Suitable grasping elements comprise gripping means or finger-like appendages, a pin, a hook, a hanger, expandable means, compression grips, insertion grips, suction means, magnets, and the like or combinations thereof. The grasping element utilized will generally depend on the dimensions, size, or measurements of the substrate to be coated. The grasping element of the electromechanical device such as the robot arm at least temporarily is connected to the substrate in one manner or another in order to perform functions and/or movements therewith.

Desirably, contact between the substrate and grasping element is minimized so that the maximum surface area of the substrate is coated. Along this line, in one embodiment, the substrate is fitted with or comprised of a tab or other appendage where the grasping element is attached and the tab or appendage removed after a predetermined series of operations are performed on the substrate, in order to maximize coating coverage of the substrate.

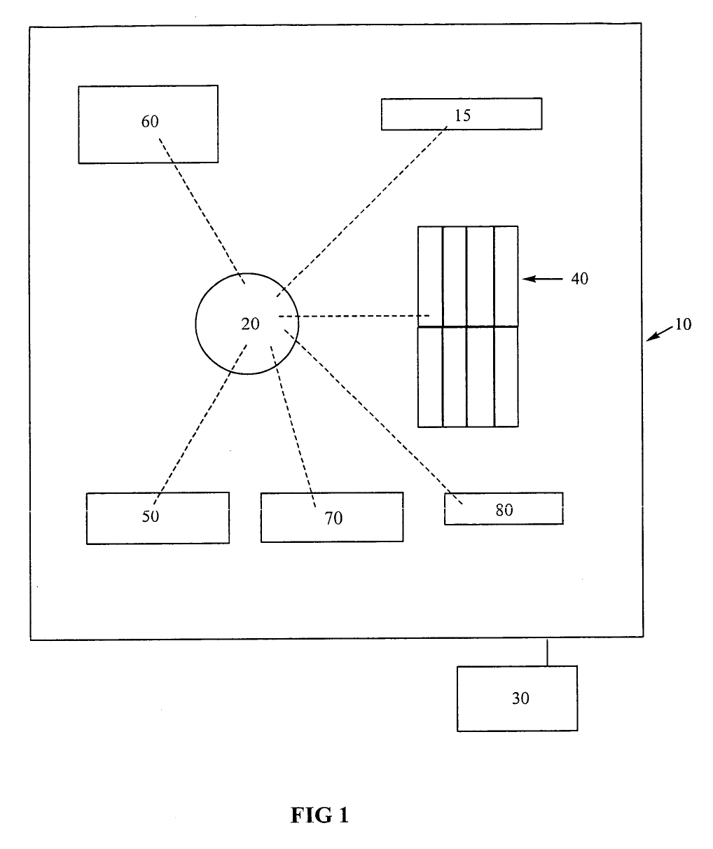

Referring now to FIG. 1, one embodiment of an autodeposition apparatus or unit 10 capable of performing the methods of the present invention is illustrated. Electromechanical device 20 is included in the apparatus and is preferably centrally located in order to perform the functions noted herein. In one embodiment, the electromechanical device is installed on a track, increasing working area. For purposes of explanation, the electromechanical device is referred to as an articulable robot arm comprising a grasping element, but is not meant to be limited thereto. In one embodiment, a single autodeposition coating is applied to an electrochemically active metal substrate. In further embodiments of the present invention, an electrochemically active metal substrate has two or more separate coatings applied thereto via autodeposition. The autodeposition dipping process is described generally below. In some embodiments, not all steps described herein are performed.

In a first step, the electromechanical device, i.e. robot arm, retrieves an electrochemically active metal substrate to be coated from a defined, registered location such as storage bin, substrate receiving area, or other pick-up point 15 for substrates conveyed to the apparatus or unit 10 utilizing the operative connection of microprocessor, central processing unit or computer 30 which is operatively connected to the electromechanical device to provide movement or operation instructions thereto.

“Induction cleaning” and “induction heating” refer to a device that supplies an alternating current to a field coil generating an electromagnetic field. The field induces eddy currents in the part material that flow against its resistivity and generates heat. The frequency of the alternating current controls the depth to which it penetrates in the part surface. Low frequencies are adaptive to heating relatively thicker parts. Higher frequencies are adaptive for smaller parts or shallow penetration. Induction heating units comprise an RF power supply for induction heating and commercially available units generally can range from 3 to 20 kW, depending on material and application requirements. Power levels and heating times are preset and matched to the characteristics of the part and the design of the induction coil. Coils are typically hollow copper tubing with circulating cooling water and vary considerably in shape according to the part geometry. Heat is generated at the surface of the part. One power supply unit can be adapted to supply several field coils. In one embodiment, one coil at one power setting used for forming the entire surface oxide layer on the part surface, and another coil at another location is preset for dehydrating the wet autodeposition coating. This second coil or a further induction coil can be employed in a presetting for final curing of the coatings.

In a preferred alternative, an autodeposition process is provided, absent any one or more conventional wet pretreatment steps and comprises a non-contact, cleaning step comprising locating the metal part in an electromagnetic field, volatilizing surface contaminants and forming an in-situ surface oxide (Fe₂O₃ and/or Fe₃O₄) pigment layer at elevated temperatures on the part, cooling the part, autodepositing a coating on the entire surface oxide layer, followed by dehydration and/or further curing. Any inductive-heat induced oxide pigment layer of from 2-about 500 nm is suitable for the entire oxide layer. The preferred surface is a blue oxide characterized by a 100-300 nm thick oxide layer and a blue-black color. A yellow color is obtainable typically where the oxide layer is from 2-20 nm thick.

Although decomposition carbon and other trace residues can remain at the oxidized surface, surprising improvements in the uniformity of autodeposition are provided having acceptable corrosion resistance that enables trouble-free automation programming as part of the process. The process can be coupled to any aqueous autodeposition coating method to replace some or all wet pre-treating steps.

In a variant of the basic process, a steel part containing a random pattern of environmental rust is subjected to an induction surface oxidizing step to form an entire induction oxide layer followed by autodepositing a surface coating, optional rinsing, dehydration or curing.

In an alternative process, the induction oxidation step is conducted in an oxygen-free atmosphere, prior to autodepositing a coating, optional rinsing, dehydration and/or curing.

In a semi automated coating process embodiment for autodepositing a coating on mil spec parts, an apparatus comprising an induction heating power supply coupled to an induction coil, a computer controlled electromechanical articulated robot arm equipped with a part or fixture engager, at least one autodeposition dip tank, and a means for dehydrating and/or curing the parts, the process comprises directing the robot arm to the part location, engaging the part or fixture of parts, passing the part or fixture in close proximity to the induction coil for a predetermined time, at a predetermined induction power setting, moving the part or fixture over the dip tank and immersing the part or fixture in an aqueous autodeposition fluid.

Parts can be individually treated, or several parts arranged on a fixture. The electromechanical coating device grasps a part or engages with the fixture. The path of the part of fixture is readily pre-programmed for passing in proximity to the EM filed around the coil. The field coil is readily shaped to direct an optimum EM filed in relation to the pre-programmed movements of the parts in proximity therewith.

In one embodiment, the surface of the substrate is prepared or cleaned utilizing cleaning device 40. The cleaning device performs a) non-chemical or mechanical cleaning, such as but not limited to grit blasting or ultrasonic wave application, or b) chemical cleaning, or a combination thereof. The cleaning device optionally contains one or more vats or dip tanks of various compositions utilized for chemically cleaning the substrate. As is known in the art, in one chemical cleaning embodiment, one cleaning tank is filled with an alkaline solution or rinse which removes oils, greases, etc. In a further embodiment, a second chemical cleaning composition or bath contains an acidic or pickling solution for cleaning soils, rust, or the like from the substrate to be coated. A preferred embodiment treats a substrate with an alkaline solution for about 2 to 4 minutes, preferably above ambient temperature, followed by ultrasonic wave cleaning from about 0.50 to about 5 or 10 minutes. Accordingly, if it is desirable to clean the electrochemically active metal substrate before applying the coating thereto, the robot arm moves or transfers the substrate from one location to the location of the cleaning unit 40.

At the cleaning unit, in a chemical cleaning embodiment the robot arm immerses all or a portion of the substrate in one or more of the cleaning solutions mentioned. Moreover, articulated motions are optionally but preferably performed while the substrate is immersed in the cleaning solution to facilitate complete cleaning of the desired areas and insure no air is entrapped in any portion of the substrate in a cavity or the like. After a predetermined period of time, the substrate is removed from the one or more cleaning solutions, optionally articulated over the bath to drain fluid, and allowed to dry or dried before a subsequent step of the method of the present invention is performed.

The substrate grasped by the robot arm is moved or transferred to a first tank, bath area, or autodeposition tank 50. The first tank is filled with a first composition which is described hereinbelow. Generally, any size tank is utilized, but preferably the volume of the tank is sufficient so that the electrochemically active metal substrate is completely immersed and articulated within the bath to facilitate proper or desired coating through autodeposition. In a more preferred embodiment, rapid bath turnover is desired and smaller quantities of the first composition are utilized.

The electrochemically active metal substrate held in the grasping element of the electromechanical device is immersed in the first tank 50 containing the first autodepositable composition. In a preferred embodiment, the electrochemically active metal substrate is articulated through one or more predetermined range of motions while immersed within the first composition to facilitate complete or substantially complete coating of the substrate by autodeposition. For example, in one embodiment the substrate is moved in an arc, up and down, rotated, turned over, or a combination thereof. Articulation within the first composition, such as by rotation or other movement, forces release of air or other substances which may be present in certain areas or cavities of the substrate.

In one embodiment, rapid bath turnover is practiced. Rapid bath turnover is defined as the replacement or replenishment of a predetermined volume of a coating composition in a period of generally from 1 hour to 5 days, and preferably from 1.5 hours to 1 day due to use or depletion. Rapid bath turnover allows utilization of inherently unstable or low stability coating compositions due to the rapid consumption thereof utilizing the methods of the present invention. In one embodiment, the coating composition components are mixed within a short amount of time, within 1 or 2 seconds to about 1 or 24 hours, prior to addition to a tank or utilization to coat electrochemically active metal substrates. In a further embodiment, a coating supply or replenishment line or system well known to those or ordinary skill in the art is utilized to add a coating composition to a tank of the present invention. The coating supply system is controlled by the microprocessor or central processing unit as known in the art, and is set to optionally mix components of a coating composition and dispense a predetermined volume of the composition into a tank for a predetermined time at predetermined intervals. In one embodiment, the volume of the electrochemically active metal substrate when immersed displaces generally at least about 0.25%, desirably at least about 1.0%, and preferably at least about 5% of the volume of the autodepositionable coating composition in the tank.

Generally, there are no restrictions as to the temperature of treatment or duration of the first composition immersion. Ordinarily, the first composition is maintained at a temperature generally from 0° C. to 50° C. and preferably from 15° C. to 25° C. The duration of the substrate immersion in the first composition is dependent primarily on predetermined desired film thickness and amount of accelerator, if any. Immersion time ranges generally from 1 to 180 seconds, and desirably from 3 to 60 seconds and preferably 5 to 10 or 30 seconds. In one embodiment, the electrochemically active metal substrate is articulated during generally from 20% to 90%, and preferably from 30% to 60% of immersion time. For example, in one embodiment immersion time is 3 to 60 seconds and the articulation takes place for 1 to 54 seconds. After the predetermined immersion time and articulated motion is completed in the first composition, the substrate is withdrawn from the first composition. The coated substrate is articulated during withdrawal in one embodiment. A preferred withdrawal method utilizes dual rate withdrawal wherein the substrate is withdrawn at two different rates, such as at a first rate of 2.54 to 25 cm/second and then at a second rate of 0.25 to 2.53 cm/second. The first rate is performed from 10 to 90% of the total withdrawal time. More than two different withdrawal rates are used in some embodiments.

In one embodiment, the withdrawn substrate is articulated through one or more predetermined motions in order to improve coating uniformity, facilitate drainage of excess or pooled material, or prevent drip edges or overly thick areas of coating from developing. For example, in various embodiments the withdrawn coated substrate is moved in an arc or other path, moved in an arc or other path with rotation, pivoted about a pivot point, such as a pivot point on the electromechanical device, or the like. In a preferred manifestation the substrate is pushed or tipped about a pivot point to an angle of generally 180° to minus 180°, and preferably from 100° to minus 100° by a tipping member such as a solenoid activated rod. In this manner, the autodeposited film is formed having a uniform thickness.

The articulated motion preferably includes multiple defined motions and/or sequences, or the like. In one embodiment, the metal based substrate coated with the first composition is articulated above the first tank so that any residual or excess coating is recovered and reenters the bath for application to a subsequent substrate. Alternatively, the electromechanical device is utilized to blot and/or wick the substrate to remove any excess coating.

In one preferred embodiment, the first tank contains an autodepositable adhesive or a metal treatment composition, which are preferably aqueous compositions. The compositions are autodeposited on an electrochemically active metal substrate in 1 to 10 or 20 seconds to provide a film thickness on the substrate of 2.5 to 25.4 micrometers, and preferably from 5.0 to 20.3 micrometers. The adhesive composition includes a flexibilizer or polymer in an amount from 10 to 90 parts by weight, an acid in an amount from 5 to 20 parts by weight, and an accelerator in an amount from 2 to 5 parts by weight, all parts per 100 parts total dry weight of the composition. The adhesive composition has a total solids content of 5 to 10% in one embodiment. The first coat adhesive composition is described further herein. The adhesive composition bonds an elastomer to the metal substrate either pre- or post vulcanization of the elastomer. Metal treatment compositions are described in greater detail hereinbelow. As known in the art, metal treatment compositions improve the adhesion of subsequent coatings such as primers and adhesive to the metal substrate and also improve corrosion resistance.

After the first composition on the electrochemically active metal substrate has been autodeposited through autodeposition utilizing the electrochemical device, the substrate is transferred to a drying device 60 as shown in FIG. 1. The term “transfer”, when utilized throughout the specification, optionally includes various movements at multiple defined velocities and paths between a number of points. During the time of performance of the various steps of the present invention, the electrochemically active metal substrate a) is maintained in a position connected to the electromechanical device grasping element, or b) is unattached or disengaged therefrom in order to perform some other task, for example, or a combination thereof.

The drying device is generally a mechanism which aids in the drying and/or curing of the autodeposited composition on the electrochemically active metal substrate. Suitable drying methods include, but are not limited to, dewatering, dehumidifying, exposure to infra-red radiation, radio frequency energy (RF), convection currents, air currents, heated zones, forced air, induction, or combinations thereof. After a predetermined amount of time, the electromechanical device, or robot arm, removes the once coated substrate from the drying device. In one embodiment, a time delay for a predetermined length of time is maintained in order to cool the substrate to a predetermined temperature before a subsequent step is performed.

In one embodiment, the coated substrate has the first autodeposited composition thereon which has been dried but not cured. Next, the autodeposited substrate is transferred to a defined, registered location for a second tank, bath, or second autodeposition tank 70 where a second coating is autodeposited thereon. The coated substrate is transferred to the second tank 70 through movement of the robot arm, with the substrate held by the grasping element thereof. The second tank is filled with a second composition which is described hereinbelow. The second composition preferably serves as top coat which is protective and/or a primer, and/or an adhesive. Any size tank and amount of autodepositable composition are utilized, but preferably the volume of the tank is sufficient so that the electrochemically active metal substrate is completely immersed and articulated within the bath to facilitate proper or desired coating through autodeposition. High bath turnover is preferably utilized as described hereinabove, for the second composition also.

The electrochemically active metal substrate held in the grasping element of the electromechanical device is immersed in the second tank 70 containing the second composition. In a preferred embodiment, the electrochemically active metal substrate is articulated through at least one predetermined motion while immersed within the second composition to facilitate complete coating of the areas of the substrate by autodeposition. Articulation within the second composition, such as by rotation or other movement, forces release of air, etc. which may be present in certain areas or cavities of the substrate. The articulated movements of the electromechanical device also assists in obtaining thorough, uniform coating coverage of the substrate.

Typically, the second composition is maintained at a temperature generally from 0° C. to 50° C. and preferably from 15° C. to 25° C. The duration of the immersion in the second composition is dependent primarily on predetermined desired film thickness, and amount of accelerator, if any. Immersion time ranges generally from 1 to 180 seconds, desirably from 3 to 60 seconds, and preferably from 5 to 30 seconds. In one embodiment, the electrochemically active metal substrate is articulated during generally from 20% to 90%, and preferably from 30% to 60% of immersion time. For example, in one embodiment immersion time is 3 to 60 seconds and the articulation takes place for 1 to 54 seconds. Accordingly, the film thickness of the second composition, when measured after drying, is generally from 0.1 mil (2.54 micrometers) to 1.0 mil (25.4 micrometers), and preferably from 0.5 mil (12.7 micrometers) to 0.8 mil (20.30 micrometers). After the predetermined immersion time and articulated motion is completed in the second composition, the substrate is withdrawn therefrom. Multiple withdrawal rates as noted hereinabove are utilized in some cases. In one embodiment, the withdrawn coated substrate is then articulated through one or more predetermined motions in order to improve coating uniformity, facilitate drainage of excess or pooled material, or prevent drip edges or overly thick areas of coating from developing. In this manner, the autodeposited film has a uniform thickness.

In one preferred embodiment, the second or subsequent autodeposition tank contains a primer composition, an adhesive autodeposition composition, an adhesive overcoat composition, or a combination thereof. The adhesive is any adhesive known in the art capable of bonding elastomers to metal either pre- or post vulcanization.

In one embodiment, the primer coating generally comprises an aqueous coating containing from about 8-25% solids, preferably from 10-20 wt. % solids, of an autodepositable resin, optional flexibilizer, optional oxidizer-accelerator. Materials diffusing from the first metal treatment step cause the deposition of the second coating, such as acid and/or phenolic resin.

In one embodiment, the second coating is applied over the first coating layer prior to drying. In another embodiment, the second coating is applied to the first coating after the first coating has been dried. The second tank contains an aqueous autodepositable overcoat which contains an autodepositable resin dispersion. Any of the known autodepositing resin compositions are employed in the second tank. Such resins are disclosed in U.S. Pat. Nos. 3,585,084; 3,592,699; 3,776,848; 3,791,431; 3,795,546; 3,829,371; 3,839,097; 3,914,519; 3,936,546; 3,955,532; 3,960,610; 4,012,351; 4,030,945; 4,103,049; 4,104,424; 4,108,817; 4,186,216; and 4,214,022, herein incorporated by reference.

As an example embodiment the second tank contains an autodepositable dispersed resin particles comprising any phenolic resole. A mixture of phenolic resoles with etherified bis-phenol-aldehyde adduct and aqueous protective colloids, such as polyvinyl alcohol/water is used.

In a specific embodiment, the overcoat second tank comprises a dispersed resole and an etherified bis-phenol adduct having a methylol functionality of from 1 to about 3.5 in an amount of from 10 wt. parts to 55 wt. parts with 90 to 45 wt. parts of a phenolic resole. More preferably 20 wt. parts to 40 wt. parts of etherified bis-phenol is combined with 80 to 60 wt. parts of a phenolic resole. Resole absent ionic-modifying agents are suitable.

Examples of other suitable autodepositable resins include carboxylated acrylic copolymers having a T_{g} of from −10 to 50° C., vinylidene chloride copolymers, dispersed colloidal particles of epoxy resins containing at least 2 epoxide groups per molecule, and mixtures of these. Commercially available autodepositable coatings include METALJACKET™ from Lord Corporation, and AUTOPHORETIC, ex. Henkel Ag. The most preferred phenolic dispersion for the overcoat is available from Lord Corporation as METALJACKET™ 2110.

The autodeposition of the second coating is activated from materials from the first metal treatment step and acid and oxidizer. A blister suppressing agent or oxidizer is optional but preferably included, such as hydroxylamine. Examples of other oxidizing agents include hydrogen peroxide, dichromate, permanganate, nitrate, persulfate, perborate, p-benzoquinone and p-nitrophenol.

In one embodiment of the second tank, an autodepositable overcoating is applied on the previously applied metal treatment formulation. In preferred embodiments, the first coating catalyzes the autodeposition of a second coating. In one embodiment the overcoating is an autodeposited adhesive capable of bonding in the vulcanization process to curable elastomers such as EPDM, natural rubber, NBR, SBR and mixtures. Especially suitable autodeposited adhesives capable of bonding the metal substrate to rubber are disclosed in U.S. Pat. No. 6,521,687, described herein. The components of the second tank in addition to the autodeposited resin include organosilanes, dispersing agents, adhesion promoting resins such as dispersion of phenol-formaldehyde condensates, crosslinkers such as nitrosobenzenes, maleimide compounds, carbon black, silica, calcium carbonate, oxides and phosphate salts of the metals Al, Ca, Zn, Mg, Pb, Zr, also zirconium salts, e.g. zirconium aluminate, and lead salts of inorganic and/or organic acids, e.g. basic lead carbonate.

The preferred adhesive formulation in the second tank comprises an autodepositable adhesive at a pH approximately 1 to 3, including an acid, a flexibilizer and an aqueous dispersion of a phenolic resin that includes water and a reaction product of a phenolic resin precursor, a modifying agent and, optionally, a multi-hydroxy phenolic compound wherein the modifying agent includes at least one phenolic-reactive functional moiety and an ionic moiety.

In some embodiments the second autodeposition composition is a latex which comprises 35 to about 60 weight % solids comprising an aqueous dispersion of a polymeric composition prepared by emulsion polymerization of vinylidene chloride with one or more comonomers selected from the group consisting of vinyl chloride, acrylic acid, a lower alkyl acrylate (such as methyl acrylate, ethyl acrylate, butyl acrylate), methacrylic acid, methyl methacrylate, acrylonitrile, methacrylonitrile, acrylamide, and methacrylamide and stabilized with sulfonic acid or sulfonic acid salt.

After the robot arm has removed the coated substrate from the second composition tank 70 and has optionally articulated the wet coated substrate, the substrate is transferred to the drying device 60 to dry the second composition which has been applied thereto. The drying conditions are preselected for drying the second composition. Drying methods have been disclosed hereinabove. For example, in one embodiment the first drying step involves RF drying or a convection oven and the second step utilizes infra-red drying or heating, etc. The substrate is removed from the drying device 60 after a predetermined time, generally such as 3 seconds to 10 minutes, and preferably from 30 seconds to 90 seconds. In a further embodiment, the coated substrate is not dried before the baking or curing step.

In a preferred embodiment, curing of the coated substrate having one or more autodeposited coatings is further undertaken in a post-dry baking or curing step known to those of ordinary skill in the art. During the baking step, the coated substrate is transferred to a registered location for the baking step to a baking device where the substrate is heated to a temperature range of generally from 300° F. (148° C.) to 700° F. (371° C.) and preferably from 300° F. (148° C.) to 375° F. (190° C.) for 1 minute to 30 minutes.

The coated substrate is then moved from the curing step location by the grasping element of the electromechanical device 20 to a receiving area 80 at a registered location. At the receiving area, the grasping element disengages from the coated substrate. The receiving area is a bin, conveyor, or packaging area, or the like. From there the coated part is taken away for further processing, packaging, or the like.

The above described process is repeated in order to produce additional coated parts or substrates in a similar manner. The use of the electromechanical device in the autodeposition process allows coated, electrochemically active metal substrates to be rapidly produced.

The autodeposition dipping method of the present invention utilizing an electromechanical device is a self-regulating dip application process which has the ability to precisely coat complex parts with a uniform, thin layer of metal treatment, coating and/or adhesive. The currently known commercial autodeposited methods of the prior art are applied utilizing either a conveyor line or an indexed rack line wherein the parts are inserted and removed from the dip application tank in a fixed orientation. The prior art process is compromised due to variable coating thickness which results from uneven drainage of the coating from the substrate.

The method for applying autodeposited systems, i.e. metal treatments, coatings, and/or adhesives, is utilized to coat complicated or complexed shaped electrochemically active metal substrates by immersion in the autodepositable bath utilizing the electromechanical device, preferably comprising a robot arm. Use of the microprocessor controlled electromechanical device allows for controlled, precise, complex immersion and withdrawal paths, such that the electrochemically active metal substrates are uniformly wetted by the autodeposited chemistry over their entire area, which are then withdrawn in a consistent, prescribed manner in such a fashion that the immersion time for any point on the part is uniform. Accordingly, the coating deposition thickness is also uniform. By withdrawing the part in a prescribed, consistent, precise manner, drip edges are eliminated and excess coating drained from any internal pockets of a complex substrate. The autodeposition method of the present invention is also particularly useful for use with autodeposited systems that are fragile wet-gels which cannot be rinsed, and where rinsing is known to compromise the performance of such autodeposited chemistries.

Numerous different coating compositions are utilized to perform the coating methods of the present invention on metal-based substrates. In one embodiment, a metal treatment composition is applied to a metal-based substrate utilizing one of the methods of the present invention. In a further embodiment, an adhesive overcoat composition or a primer composition is applied to the metal-based composition utilizing a method of the present invention. In a further embodiment, a metal-based substrate is coated with a coating composition which serves as a metal treatment, a primer, and an adhesive. In one embodiment, one method of the present invention is utilized to provide a coating on a metal-based substrate and a second different method of the present invention is utilized to provide a second or subsequent coating to the previously coated metal-based substrate. Any of the coating compositions described within this specification are utilized in any of the methods of the present invention. Any autodepositable coating compositions known to the art and to the literature are utilized. Preferred embodiments of the various coating compositions are described herein. While the coating compositions are described with respect to the film forming components, it is understood that the compositions in some embodiments also contain various additives, fillers, pigments and the like as known to those of ordinary skill in the art.

II. Coating Compositions

(A) Metal Treatment Compositions

A suitable metal surface treatment composition includes (A) an aqueous dispersion of a phenolic novolac resin that includes water and a reaction product of a phenolic resin precursor, a modifying agent and optionally a multi-hydroxy phenolic compound wherein the modifying agent includes at least one functional moiety that enables the modifying agent to react with the phenolic resin precursor and at least one ionic moiety, (B) an acid, optionally, (C) a flexibilizer, and optionally (D) an accelerator or control agent. According to one embodiment, the modifying agent is an aromatic compound. According to another embodiment, the ionic moiety of the modifying agent is sulfate, sulfonate, sulfinate, sulfenate or oxysulfonate, and a dispersed phenolic resin reaction product has a carbon/sulfur atom ratio of 20:1 to 200:1. The accelerator is preferably an organic nitro material. In one embodiment, the preferred acid is phosphoric acid. A further description of suitable phenolic resin dispersions can be found within the patents incorporated by reference in this application.

The phenolic resin dispersion can be obtained by reacting or mixing a phenolic resin precursor and a modifying agent. One functional moiety of the modifying agent provides the ionic pendant group that enables stable dispersion of the phenolic resin. Without the ionic pendant group, the phenolic resin would be unable to maintain a stable dispersion in water. Since the ionic pendant group provides for the stability of the dispersion there is no need, or at the most a minimal need, for surfactants. The presence of surfactants in an aqueous composition is a well-known hindrance to the composition's performance. The other important functional moiety in the modifying agent enables the modifying agent to react with the phenolic resin precursor. The modifying agent can contain more than one ionic pendant group and more than one reaction-enabling moiety. The acid can be any acid that is capable of adjusting the pH of the adhesive composition to 1-3. Illustrative acids include hydrofluoric acid, phosphoric acid, sulfuric acid, hydrochloric acid and nitric acid. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition. The acid preferably is present in an amount of 5 to 300 parts by weight, more preferably 10 to 160 parts by weight, based on 100 parts by weight of the phenolic resin dispersion.

In a general embodiment of the metal treatment, preferably used in a bath in the first tank for the dipping process, having a bath solids content of 3 to 20 weight %, preferably 5%-10%, and pH in the range of 1.4-3, preferably 1.4-2.5, the components include:

1. 40-50 parts by weight of an ionic modified phenol-formaldehyde resole dispersion

2. 20-30 parts of a metal activating acid

3. 1-10 parts of at least one inorganic or organic oxidizer/accelerator

4. 0-30 parts of a flexibilizer.

The following examples illustrate various active ingredients in a preferred metal treatment composition, with water bring the total wet parts to 100%. Different levels of exemplary accelerators are used at a solids content of from 5-7%.

| | Solids | Dry Parts | | | | | |
|---|---|---|---|---|---|---|---|
| Ingredient | Wt. % | Ex. 1 | Ex. 2 | Ex. 3 | Ex. 4 | Ex. 5 | Ex. 6 |
| Phenolic resin¹ | 20% | 49.6 | 49.6 | 47.6 | 44.4 | 44.4 | 44.4 |
| Phosphoric acid | 5% | 23.7 | 23.7 | 23.7 | 23.7 | 23.7 | 23.7 |
| NBR | 50% | 23.7 | 23.7 | 23.7 | 23.7 | 23.7 | 23.7 |
| NGD² | 0.6% | 1.00 | 0.50 | 0.83 | 2.73 | 2.05 | 1.36 |
| NBS³ | 2.5% | 2.00 | 2.50 | 4.17 | 5.47 | 6.15 | 6.84 |

| | |
|---|---|
| Immersion Time | 10 seconds |
| Dry Film Thickness | 15.24 micrometers |

¹sulfonate modified resole disclosed in U.S. Pat. No. 6,383,307 (Col. 22, lines 30-5)
²nitroguanidine
³sodium nitrobenzene sulfonate

In another embodiment, preferably for treatment over zinc-phosphatized steel, a metal treatment coating having a bath solids of 3%-10% and preferably 4-8% comprises from 25-45 parts of a ionic modified novolac resin; from 40-60 parts of a nitrile rubber latex flexibilizer; 2-15 parts phosphoric acid; and 2-6 parts of an organic oxidizer or accelerator, e.g. nitroguanidine; based on 100 parts by weight of the phenolic resin, flexibilizer polymer, acid, and accelerator. Preferably deionized water is used to adjust solids content. A formulation, preferably applied to zinc phosphatized steel is:

| | Wt. % | | Gram | Gram | % of |
|---|---|---|---|---|---|
| Raw Material | Solids | % Wet | Wet | Dry | Dry |
| Sulfonate-modified | 20% | 10.95 | 383.3 | 76.7 | 36.5% |
| novolac | | | | | |
| Nitrile rubber latex | 50% | 6.54 | 228.9 | 114.5 | 54.5% |
| Phosphoric acid | 5% | 6.6 | 231.0 | 11.6 | 5.5% |
| NG | 1% | 21 | 735.0 | 7.4 | 3.5% |
| DI Water | 0 | 54.91 | 1921.9 | 0.0 | 0% |
| Immersion time | 12 seconds | | | | |
| Dry film thickness | 14 micrometers | | | | |
| Total | | 100 | 3500 | 210 | 100.0% |
| Solids content of tank | 6% | | | | |

Surprisingly, after 500 hrs salt spray on scribed samples, the above metal treatment systems appeared clearly superior to E-coat at comparable dry film thickness and even lower film thickness with an almost complete absence of corrosion at the scribe line.

In one embodiment, the aqueous metal treatment coating composition tank comprises the following ingredients:

(A) an aqueous dispersion of a phenolic resin that includes a reaction product of

(i) a phenolic resin precursor;

(ii) a modifying agent, comprising a hydrocarbyl moiety bonded to at least one functional moiety that enables the modifying agent to react with the phenolic resin precursor; and at least one ionic moiety comprising an ionizable group containing sulfur and/or phosphorous,

(iii) at least one multi-hydroxyphenolic compound; and

(B) optionally an acid, wherein (iii) is optional in (A) when the reaction product (A) contains two or more reactive phenolic methylol groups.

According to one embodiment, the phenolic resin dispersion is made by reacting an aromatic hydrocarbyl moiety and an ionic moiety selected from sulfonate, sulfinate, sulfenate group, phosphono, —P(O)(OH)₂; phosphono ester —P(O)(OH)(OR); phosphonomethyl, —CH₂P(O)(OH)₂; phosphino, —P(O)(OH); and phosphinomethyl, —CH₂P(O)(OH), including combinations of any of these. The phenolic resin dispersion reaction product has a carbon/sulfur atom ratio preferably from 20:1 to 200:1.

Any phenolic resin is modified to form coating composition, such as an autodeposition composition. It has been found that phenolic resoles are especially suitable. The resole precursor should have a sufficient amount of active alkylol or benzyl ether groups that can initially condense with the modifying agent and then undergo further subsequent condensation. The phenolic resin precursor has a lower molecular weight than the final dispersed resin since the precursor undergoes condensation to make the final dispersed resin. Resoles are prepared by reacting a phenolic compound with an excess of an aldehyde in the presence of a base catalyst. Resole resins are usually supplied and used as reaction product mixtures of monomeric phenolic compounds and higher molecular weight condensation products having alkylol (—ArCH₂—OH) or benzyl ether termination (—ArCH₂—O—CH₂Ar), wherein Ar is an aryl group.

The accelerator or control agent component contains one or more oxidizers, for example, inorganic and/or organic oxidizers, such as alkali metal chlorate,—bromate,—perchlorate, -chlorite, -nitrate, -nitrite, -perborate, ammonium chlorate, ammonium bromate, ammonium perchlorate, ammonium chlorite, ammonium nitrate, ammonium nitrite, ammonium perborate, halo-substituted benzene sulfonic acid, alkali metal salt of halo-substituted benzene sulfonic acid, ammonium salt of halo-substituted benzene sulfonic acid, nitro-substituted benzene sulfonic acid, alkali metal salt of nitro-substituted benzene sulfonic acid, ammonium salt of nitro-substituted benzene sulfonic acid, and nitroguanidine.

The acid can be any acid that is capable of reacting with a metal to generate multivalent ions. Illustrative acids include hydrofluoric acid, phosphoric acid, sulfuric acid, hydrochloric acid and nitric acid. In the case of steel the multivalent ions will be ferric and/or ferrous ions. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition. The acid preferably is present in an amount of 5 to 300 parts by weight, more preferably 10 to 160 parts by weight, based on 100 parts by weight of the phenolic novolac resin dispersions (A).

Further embodiments of metal treatment compositions for use in the methods of the present invention are described in U.S. Pat. No. 6,379,752, herein incorporated by reference. Embodiments of metal treatment compositions include urethane resins, epoxy resins, polyester resins, and resins based on various acrylates. Specific examples of acrylic resins are those such as contain one or more of the following monomers: methyl acrylate, ethyl acrylate, butyl acrylate, 2-hydroxyethyl acrylate, 2-hydroxypropyl acrylate, 2-ethylhexyl acrylate, methyl methacrylate, ethyl methacrylate, n-butyl methacrylate, 2-hydroxyethyl methacrylate, 2-hydroxypropyl methacrylate, glycidyl acrylate, glycidyl methacrylate, acrylamide, methacrylamide, acrylic acid and methacrylic acid, and acrylic-alkyd resins. The latter acrylates may be present as copolymers with ethylene, styrene, vinyl chloride, vinylidene chloride and vinyl acetate. Epoxy-based resins which may also be used within the framework of the process according to the present invention are described, for example, in WO 97/07163, herein fully incorporated by reference. Apart from pure epoxy resins, epoxy acrylate-based resins are suitable. In one embodiment, after a first or metal treatment composition is applied, the coated substrate is subjected to an intermediate rinse using an aqueous solution, preferably of chromic acid or of chromates before curing or drying. The rinse step is also referred to as a reactive rinse and various concentrations of acid or of chromates are utilized. In one embodiment of the present invention, a substrate which has had a metal treatment coated thereon is subsequently rinsed in a solution or reactive rinse utilizing the electromechanical device to perform the rinse step. After the rinse step, the substrate is dried as discussed herein.

As with any of the coating compositions utilized by the methods of the present invention, other optional minor additives as adjuvants are included, depending on formulation desired. These additional components include but are not limited to thickeners; rheology modifiers; dyes; sequestering agents; biocides; dispersants; pigments, such as, titanium dioxide, organic pigments, carbon black; extenders, such as, calcium carbonate, talc, clays, silicas and silicates; fillers, such as, anti-freeze agents; plasticizers; adhesion promoters; coalescent; wetting agents; waxes; surfactants; slip additives; crosslinking agents; defoamers; colorants; tackifiers; waxes; preservatives; freeze/thaw protectors, corrosion inhibitors; anti-flocculants; and alkali or water soluble polymers.

(B) One Coat Adhesive Composition

In a preferred embodiment, the composition applied to an electrochemically active metal substrate by the method of the present invention is a one-coat adhesive. The one-coat adhesive is applied a) directly to an electrochemically active metal substrate or b) over a substrate having a coating composition, such as an autodeposited composition previously applied thereto. The one-coat adhesive is used to bond elastomers to metals.

One preferred adhesive composition allows for the rapid autodeposition onto an electrochemically active metal substrate in a cycle time of 1 to 10 seconds. The cycle time permits the composition to be applied to the substrate utilizing the microprocessor controlled electromechanical device or system. A preferred adhesive composition comprises an autodepositable flexibilizer polymer, an acid, an accelerator, and optionally a phenolic resin.

The flexibilizer polymer is generally a latex that coagulates when exposed to the metallic ions present on the metallic substrate to form a film of uniform thickness. Suitable flexibilizer polymers are described herein. The flexibilizer polymer is present in an amount from 10 to 70 parts, and preferably 15 or 20 to 60 parts per 100 parts by dry weight of the flexibilizer, acid, accelerator and optional phenolic resin in the adhesive composition. Preferred flexibilizer polymers include styrene acrylic polymer latex and nitrile rubber latex.

Acids suitable for use in the adhesive composition have been described herein with phosphoric acid being preferred. Suitable amounts of the acid ranges generally from 5 to 20 parts and preferably from 7 to 15 parts per 100 parts dry weight of the flexibilizer, acid, accelerator and optional phenolic resin in the adhesive composition. The acid generates the metal ions of the substrate thereby activating the surface allowing coagulation of the flexibilizer polymer. The accelerator component improves the formation of the autodeposited coating on the metal substrate. The accelerator is also a crosslinker capable of bonding rubber to metal.

The accelerant or control agent may be a nitro compound, a nitroso compound, all oxime compound, a nitrate compound, or a similar material. A mixture of accelerants are used. Organic nitro compounds are the preferred accelerants.

The organic nitro compound is any material that includes a nitro group (—NO₂) bonded to an organic moiety. Preferably, the organic nitro compound is water soluble or, if water insoluble, capable of being dispersed in water. Illustrative organic nitro compounds include nitroguanidine; aromatic nitrosulfonates such as nitro or dinitrobenzenesulfonate and the salts thereof such as sodium, potassium, amine or any monovalent metal ion (particularly the sodium salt of 3,5-dinitrobenzenesulfonate); Naphthol Yellow S; and picnic acid (also known as trinitrophenol). Especially preferred for commercial availability and regulatory reasons is nitroguanidine, a mixture of nitroguanidine and sodium nitrobenzenesulfonate.

The amount of accelerants in a multi-component composition may vary, particularly depending upon the amount of any acid in the composition. Preferably, the amount is up to 20 parts, more preferably up to 10 parts, and most preferably 2 to 5 parts per 100 parts dry weight of the flexibilizer, acid, accelerator and optional phenolic resin in the adhesive composition. According to a preferred embodiment, the weight ratio of nitroguanidine to sodium nitrobenzenesulfonate should range from 1:10 to 5:1.

The organic nitro compound typically is mixed into the composition in the form of an aqueous solution or dispersion. For example, nitroguanidine is a solid at room temperature and is dissolved in water prior to formulating into the composition.

In a preferred embodiment the solids content of the adhesive composition is from 1 to 20 percent and preferably from 6 to 10 percent.

According to another adhesive embodiment, the adhesive is a one coat adhesive having a low pH (approximately 1-3) and includes (A) a flexibilizer or film-former, (B) optionally, an aqueous dispersion of a phenolic resin that includes water and a reaction product of a phenolic resin precursor, a modifying agent and, optionally, a multi-hydroxy phenolic compound, wherein the modifying agent includes at least one functional moiety that enables the modifying agent to react with the phenolic resin precursor and at least one ionic moiety, and (C) an acid. According to a more preferred embodiment of a one coat adhesive, the adhesive further includes a control agent that improves the uniformity of the film thickness formed by the adhesive. Organic nitro compounds are the preferred control agents. According to another particular embodiment of a one coat adhesive, the adhesive further includes a crosslinker that improves the adhesive performance. The crosslinker is preferably an aromatic nitroso compound or aromatic nitroso compound precursor. In one preferred embodiment, the one-coat adhesive is autodeposited on a metal substrate utilizing the electromechanical device. After further optional steps are completed, an elastomeric substrate is contacted to the coated metal substrate to effect bonding of the metal substrate to the elastomeric substrate.

The adhesive preferably contains a flexibilizer polymer. The flexibilizer is any material that contributes flexibility and/or toughness to the film formed from the composition. The toughness provided by the flexibilizer provides fracture resistance to the film. The flexibilizer should be non-glassy at ambient temperature and be an aqueous emulsion latex or aqueous dispersion that is compatible with the phenolic resin dispersion. The flexibilizer preferably is formulated into the composition in the form of an aqueous emulsion latex or aqueous dispersion.

Suitable flexibilizers include aqueous latices, emulsions or dispersions of (poly)butadiene, neoprene, styrene-butadiene rubber, acrylonitrile-butadiene rubber (also known as nitrile rubber), halogenated polyolefin, acrylic polymer, urethane polymer, ethylene-propylene copolymer rubber, ethylene-propylene-diene terpolymer rubber, styrene-acrylic copolymer, polyamide, poly(vinyl acetate) and the like. Halogenated polyolefins, nitrile rubbers and styrene-acrylic copolymers are preferred.

A suitable styrene-acrylic polymer latex is commercially available from Goodyear Tire & Rubber under the trade designation PLIOTEC and described, for example, in U.S. Pat. Nos. 4,968,741; 5,122,566 and 5,616,635. According to U.S. Pat. No. 5,616,635, such a copolymer latex is made from 45-85 weight percent vinyl aromatic monomers, 15-50 weight percent of at least one alkyl acrylate monomer and 1-6 weight percent unsaturated carbonyl compound. Styrene is the preferred vinyl aromatic monomer, butyl acrylate is the preferred acrylate monomer and acrylic acid and methacrylic acid are the preferred unsaturated carbonyl compound.

The flexibilizer or overcoating polymer is derived from polymerization of various co-monomers such as acrylic acid or various esters thereof, dicarboxylic acids, α-haloacrylonitriles such as α-bromoacrylonitrile and α-chloroacrylonitrile; α,β-unsaturated carboxylic acids such as acrylic, methacrylic, 2-ethylacrylic, 2-propylacrylic, 2-butylacrylic and itaconic acids; alkyl-2-haloacrylates such as ethyl-2-chloroacrylate and ethyl-2-bromoacrylate; α-bromovinylketone; vinylidene chloride; vinyl toluenes; vinylnaphthalenes; vinyl ethers, esters and ketones such as methyl vinyl ether, vinyl acetate and methyl vinyl ketone; esters amides, and nitriles of acrylic and methacrylic acids such as ethyl acrylate, methyl methacrylate, glycidyl acrylate, methacrylamide and acrylonitrile; and combinations of such monomers.

Suitable flexibilizers or overcoating polymers include polymers based on polyvinyl butyral and are disclosed in U.S. Pat. No. 6,433,079, herein fully incorporated by reference. Phenoxy resins based on aromatic polyether resins are also suitable flexibilizers or overcoating materials. Phenoxy resins are well known in the art and are also referred to as poly [bisphenol A-co epichlorohydrin]. They typically have molecular weights in the 20,000 range. Phenoxy resins are distinguished from thermosetting epoxy resins. Phenoxy resins are suitable overcoating polymers and are commercially available, such as Paphen® resins, PKHP 200 from Phenoxy Specialities, and from Dow Chemical under the Blox™ brand.

Suitable film forming flexibilizer and/or overcoating resins include vinylidene chloride latexes available From DOW Chemical, Imperial Chemical Industries, and Morton Chemical. Preferred film forming flexibilizers include halogenated polyolefins, chlorinated natural rubber, chlorine- and bromine-containing synthetic rubbers including polychloroprene, chlorinated polychloroprene, chlorinated polybutadiene, hexachloropentadiene, butadiene/halogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, poly(2,3-dichloro-1,3-butadiene), brominated poly(2,3-dichloro-1,3-butadiene), copolymers of α-haloacrylonitriles and 2,3-dichloro-1,3-butadiene, chlorinated poly(vinyl chloride) and the like including mixtures of such halogen-containing film formers. A specific example of a film forming flexibilizer is chloroprene-styrene sulfonic acid-2,3-dichlorobutadiene latex. The preferred film forming flexibilizers are latexes of chlorosulfonated polyethylene, poly(2,3-dichloro-1,3-butadiene), brominated poly(2,3-dichloro-1,3-butadiene), copolymers of α-haloacrylonitriles and 2,3-dichloro-1,3-butadiene.

Solution or bulk polymerized flexibilizer polymers, not originally made as aqueous dispersions or emulsion polymers is converted to aqueous dispersions according to methods known in the art by converting organic solutions thereof into oil-in-water dispersions using a minimum stabilizing amount of monomeric and/or polymeric anionic emulsifiers and stabilizers. For example, a halogenated polyolefin is taken up in solvent. A mixture of water and emulsifier/stabilizer is added slowly under substantial agitation that provides a shearing action to the solution. Suitable representative non-polymeric anionic surfactants or emulsifiers that may be employed for converting solutions to aqueous dispersions are alkyl or aryl sulfates, alkyl or aryl sulfonates, alkyl or aryl phosphates, alkyl or aryl phosphonates, and alkyl or aryl carboxylates, and mixtures. Specific examples of anionic surfactants include sodium laural sulfate, sodium dodecyl sulfate, Triton® H-55, and monosodium N-cocyl-L-glutamate. Anionic surfactants are used alone or in combination with hydrophilic polymeric stabilizers. Upon conversion of the solution under high shear to an emulsion of the polymer, solvent is then stripped.

Autodepositable flexibilizers and overcoating polymers are readily prepared under known emulsion polymerization methods. In the embodiment employing phenolic resole dispersions, butadiene latices are particularly preferred as the flexibilizer, with nitrile butadiene copolymers being most preferred. Methods for making butadiene latices are well-known and are described, for example, in U.S. Pat. Nos. 4,054,547 and 3,920,600, both incorporated herein by reference. In addition, U.S. Pat. Nos. 5,200,459; 5,300,555; and 5,496,884 disclose emulsion polymerization of butadiene monomers in the presence of polyvinyl alcohol and a co-solvent such as an organic alcohol or a glycol. Nitrile lattices are commercially available from Noveon (formerly BFGoodrich Specialty Chemicals). Latexes, or converted dispersions may stabilized with the aforementioned monomeric anionic surfactants, hydrophilic polymeric dispersants derived from acrylic or methacrylic acid, acrylamide, substituted acrylamide; sodium vinyl sulfonate; phosphoethyl(meth)acrylate; acrylamido propane sulfonate; diacetone acrylamide; glycidyl methacrylate; acetoacetyl ethylmethacrylate and combinations thereof.

A preferred film forming latex contains bound ionic groups incorporated by aqueous polymerization techniques that involve polymerizing butadiene monomer in the presence of ethylenically functional ionic compounds such as styrene sulfonate, styrene sulfonate, poly(styrene sulfonic acid), poly(styrene sulfonate) stabilizer, sodium sulfoalkyl methacrylate, and the like. The sulfonates are salts of any cationic groups such as sodium, potassium or quaternary ammonium. Sodium styrene sulfonate is a preferred styrene sulfonate compound. Poly(styrene sulfonate) polymers include poly(styrene sulfonate) homopolymer and poly(styrene sulfonate) copolymers such as those with maleic anhydride. Sodium salts of poly(styrene sulfonate) are particularly preferred and are commercially available from National Starch under the trade designation VERSA® TL. The poly(styrene sulfonate) can have a weight average molecular weight from 5×10⁴ to 1.5×10⁶, with 1.5×10⁵ to 2.5×10⁵ being preferred. In the case of a poly(styrene sulfonate) or poly(styrene sulfonic acid) emulsion polymerization takes place in the presence of the pre-formed polymer.

The phenolic resin dispersion (B) is optional component, but typically is present in the one coat adhesive embodiment. The phenolic resin dispersion (B) is disclosed in commonly assigned PCT Patent Application Publication No. WO 99/37712, corresponding to U.S. patent application Ser. No. 09/235,777, filed Jan. 22, 1999, incorporated herein by reference. The phenolic resin dispersion (B) of the inventive composition is obtained by reacting or mixing a phenolic resin precursor and a modifying agent—theoretically via a condensation reaction between the phenolic resin precursor and the modifying agent. The phenolic resin, when present, is utilized in an amount of 5 to about 50 parts, and preferably 15 to 35 parts per 100 parts dry weight of the flexibilizer, acid, accelerator and optional phenolic resin in the adhesive composition.

The acid (C) is any acid that is capable of adjusting the pH of the adhesive composition to 1-3. Illustrative acids include hydrofluoric acid, phosphoric acid, sulfuric acid, hydrochloric acid and nitric acid. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition.

In a preferred embodiment, an adhesive coating composition which is preferably applied to cold rolled steel or zinc treated steel, having a bath solids of 3 to 15% and preferably 4-8%, comprises from 20-40 parts of a novlak phenolic resin, 40-60 parts of a nitrile rubber latex flexibilizer, 2-6 parts of an accelerator, and 10-15 parts phosphoric acid, based on 100 parts by weight of the phenolic resin, flexibilizer, acid and accelerator. Preferably, deionized water is used to adjust the solids content. A preferred formulation is as follows:

| | Wt. % | | Gram | Gram | % of |
|---|---|---|---|---|---|
| Raw Material | Solids | % Wet | Wet | Dry | Dry |
| Carbon Black | 2% | 40.95 | 140.5 | 0.95 | 9% |
| Novolak Phenolic Resin | 20% | 13.00 | 44.6 | 2.60 | 27% |
| Phosphoric acid | 10% | 9.60 | 32.9 | 0.96 | 10% |
| Nitroguanidine | 1% | 36.00 | 123.5 | 0.36 | 4% |
| Nitrile Rubber Latex | 25% | 19.20 | 65.9 | 4.80 | 50% |
| Water | 0% | 27.00 | 92.6 | 0.00 | 0% |
| Total | | 145.75 | 500.0 | 9.67 | 100.0% |
| Solids content of tank | 7% | | | | |

(C) Aqueous Primer Coating

In a preferred embodiment one coating for use in the methods of the present invention is a primer. In one embodiment, a suitable primer is disclosed in U.S. Pat. No. 6,476,119 herein incorporated by reference. In one preferred embodiment, the primer composition is utilized as a second coating in the electromechanical device autodeposition method. In this embodiment, the primer includes (A) an aqueous dispersion of a phenolic resin that includes water and a reaction product of a phenolic resin precursor, a modifying agent and, optionally, a multi-hydroxy phenolic compound wherein the modifying agent includes at least one functional moiety that enables the modifying agent to react with the phenolic resin precursor and at least one ionic moiety, and (B) a flexibilizer. According to one embodiment the modifying agent is an aromatic compound. According to another embodiment the ionic moiety of the modifying agent is sulfate, sulfonate, sulfinate, sulfenate or oxysulfonate and the dispersed phenolic resin reaction product has a carbon/sulfur atom ratio of 20:1 to 200:1.

The aqueous dispersion of phenolic resin and flexibilizer have been described herein. The flexibilizer is preferably present in the primer composition in an amount from 5 parts by weight to 300 parts by weight, based on 100 parts by weight of the phenolic resin dispersion. More preferably, the flexibilizer is present in an amount of 25 parts by weight to 100 parts by weight, based on 100 parts by weight of the phenolic resin dispersion. In a further preferred embodiment, the primer composition additionally includes an aldehyde, preferably formaldehyde, donor compound that is capable of crosslinking the phenolic resin.

(D) Adhesive Overcoat Composition

In yet an additional embodiment, an adhesive overcoat composition for bonding two substrates, such as an elastomer to a metal, is utilized in the coating methods of the present invention. The adhesive overcoat composition includes (A) a flexibilizer or film-former, (B) an aqueous dispersion of a phenolic resin that includes a reaction product of a phenolic resin precursor, a modifying agent and, optionally, a multi-hydroxy phenolic compound wherein the modifying agent includes at least one functional moiety that enables the modifying agent to react with the phenolic resin precursor and at least one ionic moiety, and (C) a crosslinker. The adhesive overcoat composition is versatile and in a first embodiment is an autodeposition coating composition in any of the methods of the present invention.

The adhesive overcoat compositions are generally two-part rubber to metal adhesive systems with the (B) aqueous dispersion of phenolic resin component and the (C) crosslinker separated in different parts prior to mixing. The remaining components are present in one part or split between both parts with the ratio of the split not being critical. The two-part system is mixed prior to application to a substrate by one of the methods of the present invention. Unexpectedly, it has been found that adhesive overcoat composition has excellent stability when formulated as a single part composition or mixed from a two-part system. In one preferred embodiment, the stability of the combined components of the adhesive overcoat composition ranges from a few hours to days, weeks, and even months. Accordingly, the adhesive overcoat compositions are not necessarily two component systems, and in one embodiment are formed as a one-part composition.

In a preferred embodiment, the adhesive overcoat compositions are applied to a treated electrochemically active metal substrate, preferably over a primer or metal treatment composition. In one embodiment, an acid component is included in the adhesive overcoat composition, which is then directly applied to an electrochemically active metal substrate. An accelerator component is utilized in a further embodiment. The application methods of the present invention enable the composition to form a self-limiting substantially uniform film.

In a preferred embodiment the crosslinker is an aromatic nitroso compound or aromatic nitroso compound precursor. The aromatic nitroso compound is any aromatic hydrocarbon, such as benzenes, naphthalenes, anthracenes, biphenyls, and the like, containing at least two nitroso groups attached directly to non-adjacent ring carbon atoms. Such aromatic nitroso compounds are described, for example, in U.S. Pat. No. 3,258,388; U.S. Pat. No. 4,119,587 and U.S. Pat. No. 5,496,884. The aromatic nitroso compound or aromatic nitroso compound precursor, if present, is preferably in an amount of 5 to 60, more preferably 20 to 30, weight percent, based on the total dry weight of the adhesive. An aromatic nitroso compound precursor is preferred.

More particularly, such nitroso compounds are described as aromatic compounds having from 1 to 3 aromatic nuclei, including fused aromatic nuclei, having from 2 to 6 nitroso groups attached directly to non-adjacent nuclear carbon atoms. The preferred nitroso compounds are the dinitroso aromatic compounds, especially the dinitrosobenzenes and dinitrosonaphthalenes, such as the meta- or para-dinitrosobenzenes and the meta- or para-dinitrosonaphthalenes. The nuclear hydrogen atoms of the aromatic nucleus can be replaced by alkyl, alkoxy, cycloalkyl, aryl, aralkyl, alkaryl, arylamine, arylnitroso, amino, halogen and similar groups. Thus, where reference is made herein to “aromatic nitroso compound” it will be understood to include both substituted and unsubstituted nitroso compounds.

Particularly preferred nitroso compounds are characterized by the formula

(R)ₘ—Ar—(NO)₂,

wherein Ar is selected from the group consisting of phenylene and naphthalene; R is a monovalent organic radical selected from the group consisting of alkyl, cycloalkyl, aryl, aralkyl, alkaryl, arylamine and alkoxy radicals having from 1 to 20 carbon atoms, amino, or halogen, and is preferably an alkyl group having from 1 to 8 carbon atoms; and m is 0, 1, 2, 3, or 4, and preferably is 0.

Exemplary suitable aromatic nitroso compounds include m-dinitrosobenzene, p-dinitrosobenzene, m-dinitrosonaphthalene, p-dinitrosonaphthalene, 2,5-dinitroso-p-cymene, 2-methyl-1,4-dinitrosobenzene, 2-methyl-5-chloro-1,4-dinitrosobenzene, 2-fluoro-1,4-dinitrosobenzene, 2-methoxy-1-3-dinitrosobenzene, 5-chloro-1,3-dinitrosobenzene, 2-benzyl-1,4 -dinitrosobenzene, 2-cyclohexyl-1,4-dinitrosobenzene and combinations thereof. Particularly preferred are m-dinitrosobenzene and p-dinitrosobenzene.

The aromatic nitroso compound precursor may be essentially any compound that is capable of being converted, typically by oxidation, to a nitroso compound at elevated temperatures, typically from about 140-200° C. This conversion usually occurs during the bonding procedure used with the adhesive. The most common aromatic nitroso compound precursors are quinone compounds. Examples of such quinone compounds include quinone dioxime, dibenzoquinone dioxime, 1,2,4,5-tetrachlorobenzoquinone, 2-methyl-1,4-benzoquinone dioxime, 1,4-naphthoquinone dioxime, 1,2-naphthoquinone dioxime and 2,6-naphthoquinone dioxime. Quinone dioxime is especially preferred.

The additional components of the adhesive overcoating composition, specifically the flexibilizer and phenolic resin have been described elsewhere within the specification or patents incorporated by reference and are herein incorporated. In one preferred embodiment the flexibilizer is present in an amount from 30 to 50 parts by weight, the crosslinker is present in an amount from 30 to 50 parts by weight, and the phenolic resin is present in an amount from 5 to about 20 parts by weight, based on 100 parts dry weight of the adhesive overcoating composition. As is known in the art, additional additives, fillers, pigments such as carbon black, etc. can be used in the composition. The adhesive overcoat composition includes a predetermined amount of water to adjust the solids content between a range of generally 5 to 40%, and preferably from 7 to 25%. One of ordinary skill in the art is able to adjust the solids content depending on the particular application.

In one embodiment, a preferred adhesive overcoat composition is formed from the following two component systems; the separate components are mixed in a 1:1 ratio by weight before use in an autodeposition process.

COMPONENT A

| | | | Wet Wt. | % of |
|---|---|---|---|---|
| Raw Material | % Solids | Dry Wt. in gms | in gms | Dry Wt. |
| Novolac phenolic | 20% | 96 | 480 | 29% |
| resin | | | | |
| Flexibilizer | 33.6% | 240 | 720 | 71% |
| Water | | | 1400 | |
| Total Weight | | 336 | 2600 | 100% |
| % Solids | 13% | | | |

COMPONENT B

| | | | Wet Wt. | |
|---|---|---|---|---|
| Raw Material | % Solids | Dry Wt. in gms | in gms | % of Dry Wt. |
| Flexibilizer | 33.6% | 80 | 240 | 19% |
| Crosslinker | 78.5% | 320 | 410 | 76% |
| Dispersion Aid | 100% | 10 | 10 | 2% |
| Carbon Black | 100% | 10 | 10 | 2% |
| Water | | | 1280 | |
| Total Weight | | 420 | 1950 | 100% |
| % Solids | 22% | | | |

In a further preferred embodiment, the phenolic resin is a resorcinol based novolac, the flexibilizer is chlorinated diene polymer, preferably 2,3-dichloro-1,3 butadiene, the crosslinker is dinitrosobenzene.

The methods of the present invention are utilized, for example, to coat parts such as nuts, bolts, washers, screws, bushings, bottles, containers, cans, sleeves, shims, bands, rotors, tubeforms (cylinders), wires, cables, gskets, seals, TVD-tortional vibration dampers, strut towers, and gun barrels. The present invention is preferably practiced on small scale production lines, saving floor space and costs associated therewith.

We claim:

1. A method for coating a metal substrate, comprising the steps of:
retrieving a metal substrate with a grasping element of an articulative electromechanical device;
bringing said substrate into contact with a first autodepositing composition for a predetermined period of time forming a first film on a surface of said substrate;
articulating said substrate either in said first composition, or a combination thereof, after contact with said first composition for a predetermined period of time, with said electromechanical device.

2. A method according to claim 1, wherein said first film has a dry film thickness of 2.5 to 25.4 micrometers.

3. A method according to claim 2, wherein said contact with said first composition is from 1 to 180 seconds.

4. A method according to claim 3, wherein said articulating step is performed while said metal substrate is in contact with said first autodepositing composition and after contact with said first autodepositing composition.

5. A method according to claim 2, further comprising the step of drying said substrate in a drying device after said first autodeposited film has been formed.

6. A method according to claim 1, further comprising the steps of bringing said substrate into contact with a second autodepositing composition for a predetermined period of time to form a second film on said substrate, and articulating said substrate either in said second composition, or after contact with said second composition, or a combination thereof for a predetermined period of time, with said electromechanical device.

7. A method according to claim 6, wherein said second film has a dry film thickness of 2.5 to 25.4 micrometers.

8. A method according to claim 7, wherein said first autodepositing composition is a metal treatment, or an adhesive composition, and wherein said second autodepositing composition is a primer composition or an adhesive overcoat composition.

9. A method according to claim 2, wherein said first composition comprises a) a metal treatment comprising an acid, and a phenolic resin, or b) an adhesive composition comprising a flexibilizer, and an acid.

10. A method according to claim 7, wherein said second composition is a) a primer comprising a phenolic resin and a flexibilizer, or b) an adhesive overcoat composition comprising a flexibilizer, and phenolic resin and a crosslinker.

11. A method according to claim 7, wherein substrate is dried in a drying device after coating with each said first and second compositions, wherein said drying utilizes infra-red radiation, radio frequency energy, convection currents, air currents, heated zones, forced air, induction, or a combination thereof, and wherein said bringing of said substrate into contact comprises immersion.

12. A method according to claim 3, wherein bringing said substrate into contact comprises immersion, and wherein said electromechanical device comprises a microprocessor which operatively controls a robot arm.

13. A method according to claim 12, wherein said immersion ranges from 3 to 60 seconds.

14. A method according to claim 13, wherein said articulation is performed from 20% to 90% of immersion time.

15. A method according to claim 4, wherein said electromechanical device comprises a robot arm, and where said grasping element is a grasping means, pin, hook, hanger, expandable means, compression grip, insertion grip, suction means, magnet, or a combination thereof, wherein said substrate displaces at least 0.25% of a volume of the first autodepositing composition in a tank, and wherein said first composition has a bath turnover of about 1 hour to about 5 days.

16. A method according to claim 11, wherein said electromechanical device comprises a robot arm, and where said grasping element is a grasping means, pin, hook hanger, expandable means, compression grip, insertion grip, suction means, magnet, or a combination thereof, wherein said substrate displaces at least 0.25% of a volume of the first autodepositing composition in a tank, and wherein said first composition has a bath turnover of about 1 hour to about 5 days.

17. A method according to claim 4, further including the step of cleaning the substrate utilizing a cleaning device, and wherein said cleaning device comprises mechanical cleaning, chemical cleaning, or a combination thereof.

18. A method according to claim 11, further including the step of cleaning the substrate utilizing a cleaning device, and wherein said cleaning device comprises mechanical cleaning, chemical cleaning, or a combination thereof.

19. A method for coating a metal substrate, comprising the steps of: retrieving a metal-based substrate with a grasping element of an electromechanical device;
bringing said substrate into contact with a first autodepositing composition for a predetermined period of time forming a first film on a surface of said substrate;
articulating said substrate either in said first composition, or after contact with said first composition, or a combination thereof for a predetermined period of time, with said electromechanical device;
bringing said substrate into contact with a second autodepositing composition for a predetermined period of time forming a second film on said substrate; and
articulating said substrate either in said second composition, or after contact with said second composition, or a combination thereof for a predetermined period of time, with said electromechanical device.

20. A method according to claim 19, wherein said first and second films individually have a dry film thickness of 2.5 to 25.4 micrometers.

21. A method according to claim 20, wherein said contact with said first and second films compositions individually is from 1 to 180 seconds.

22. A method according to claim 21, wherein said articulating step is performed while said metal substrate is in contact with said first autodepositing composition and after contact with said first autodepositing composition, and wherein said articulating step is performed while said metal substrate is in contact with said second autodepositing composition and after contact with said second autodepositing composition.

23. A method according to claim 20, further comprising the steps of drying said substrate in a drying device after said first autodeposited film has been formed, and drying said substrate in a drying device after said second autodeposited film has been formed.

24. A method according to claim 21, wherein said first autodepositing composition is a metal treatment, or an adhesive composition, and wherein said second autodepositing composition is a primer composition or an adhesive overcoat composition.

25. A method according to claim 21, wherein said first composition comprises a) a metal treatment comprising an acid, and a phenolic resin, or b) an adhesive composition comprising a flexibilizer, and an acid, and wherein said second composition is a) a primer comprising a phenolic resin and a flexibilizer, or b) an adhesive overcoat composition comprising a flexibilizer, and phenolic resin and a crosslinker.

26. A method according to claim 23, wherein said drying utilizes infra-red radiation, radio frequency energy, convection currents, air currents, heated zones, forced air, induction, or a combination thereof, and wherein said bringing of said substrate into contact comprises immersion.

27. A method according to claim 21, wherein bringing said substrate into contact comprises immersion, and wherein said electromechanical device comprises a microprocessor which operatively controls a robot arm.

28. A method according to claim 27, wherein said immersion ranges from 3 to 60 seconds.

29. A method according to claim 28, wherein said articulation is performed from 20% to 90% of immersion time.

30. A method according to claim 21, wherein said electromechanical device comprises a robot arm, and where said grasping element is a grasping means, pin, hook, hanger, expandable means, compression grip, insertion grip, suction means, magnet, or a combination thereof, wherein said substrate displaces at least 0.25% of a volume of the first autodepositing composition in a tank, and wherein said first composition has a bath turnover of about 1 hour to about 5 days.

31. A method according to claim 25, wherein said electromechanical device comprises a robot arm, and where said grasping element is a grasping means, pin, hook hanger, expandable means, compression grip, insertion grip, suction means, magnet, or a combination thereof, wherein said substrate displaces at least 0.25% of a volume of the first autodepositing composition in a tank, and wherein said first composition has a bath turnover of about 1 hour to about 5 days.

32. A method according to claim 21, further including the step of cleaning the substrate utilizing a cleaning device, and wherein said cleaning device comprises mechanical cleaning, chemical cleaning, or a combination thereof.

33. A method according to claim 25, further including the step of cleaning the substrate utilizing a cleaning device, and wherein said cleaning device comprises mechanical cleaning, chemical cleaning, or a combination thereof.
